(19) United States
(12) Patent Application Publication
(10) Pub. No.: US 2026/0237364 A1
(43) Pub. Date: Aug. 13, 2026

(54) GAMMA VOLTAGE COMPENSATION CIRCUIT, COMPENSATION METHOD AND DISPLAY DEVICE

(71) Applicant: HKC CORPORATION LIMITED, Shenzhen (CN)

(72) Inventors: JIAN PENG, Shenzhen (CN); XIANG GAO, Shenzhen (CN); LIDAN YE, Shenzhen (CN)

(21) Appl. No.: 19/168,875

(22) PCT Filed: Oct. 27, 2023
(86) PCT No.: PCT/CN2023/127126

§ 371 Date: Sep. 25, 2025

(30) Foreign Application Priority Data
Apr. 18, 2023 (CN) 202310413304.X

(51) Int. Cl. G09G 5/10

(52) U.S. Cl. CPC G09G 5/10; G09G 2310/08; G09G 2320/0247; G09G 2320/0626; G09G 2320/0673; G09G 2340/0435

(57) ABSTRACT

A gamma voltage compensation circuit includes an input sub-circuit (110), a rectifier (130), a compensator (150), and an output sub-circuit (160). The input sub-circuit (110) is configured for inputting a base gamma voltage, and the rectifier (130) is configured for converting a frame start signal to a reference voltage (Vref). The compensator (150) is configured for generating a gamma compensation voltage based on the reference voltage (Vref). The output sub-circuit (160) configured for superimposing the base gamma voltage and the gamma compensation voltage to generate a target gamma voltage and output the target gamma voltage to a data driver chip of the display panel (200). The voltage difference between the target gamma voltage and the common voltage (Vcom) is negatively related with the reference voltage (Vref).

### CROSS-REFERENCE TO RELATED APPLICATIONS

This application is a national stage entry under 37 U.S.C. § 371 of International Application No. PCT/CN2023/127126, filed Oct. 27, 2023, which claims priority to Chinese Patent Application CN 202310413304.X, filed on Apr. 18, 2023, the entire disclosures of which are incorporated herein by reference.

### TECHNICAL FIELD

The present application belongs to the field of display, and particularly relates to a gamma voltage compensation circuit, a compensation method and a display device.

### BACKGROUND

Variable Refresh Rate (VRR) mode allows the display to refresh at rates ranging from 48 Hz to 144 Hz, so that the screen refresh rate can be matched with the display images in real time, thereby avoiding lagging and tearing of the display images caused by different frequencies.

The refresh rate of the display screen is switched in real time, and since refresh rates are different, blank (V-blank) regions are different and current leakage of the transistors are different. The lower the refresh rate, the longer the V-blank region, the more current leakage of the transistor. The higher the refresh rate, the shorter the V-blank region, the less the current leakage of the transistors. The transistor is connected to the pixel electrode, and when the current leakage of transistor is different, the voltage of the pixel electrode is different. Therefore, even if the gamma voltage is the same, real-time switching of the refresh rate of the display will lead to instability of the voltage of the pixel electrode, thereby resulting in differences in the brightness of the display screen, and the visible flicker occurs on the display screen.

### SUMMARY

There are provided a gamma voltage compensation circuit, a compensation method, and a display device to compensate a gamma voltage according to embodiments of the present disclosure. The technical solution is as below.

According to a first aspect of the present application, the present application provides a gamma voltage compensation circuit, including:
an input sub-circuit, connected to a gamma chip for inputting a base gamma voltage;
a rectifier, connected to a frame start signal line for converting a frame start signal into a reference voltage;
a compensator, connected to the rectifier for generating a gamma compensation voltage based on the reference voltage; and
an output sub-circuit, connected to the input sub-circuit, the compensator and a display panel, for superimposing the base gamma voltage and the gamma compensation voltage to generate a target gamma voltage, and outputting the target gamma voltage to a data driver chip of the display panel;
a voltage difference between the target gamma voltage and a common voltage is negatively related to the reference voltage.

According to a second aspect of the present application, the present application provides a gamma voltage compensation method, including:

generating, by a gamma chip, a base gamma voltage in a bright state;
compensating, by a gamma voltage compensation circuit, the base gamma voltage to obtain a target gamma voltage;
compensating a gamma binding point voltage based on the target gamma voltage and a preset gamma curve.

According to a third aspect of the present application, the present application provides a display device, including a gamma voltage compensation circuit, a gamma chip and a display panel, the gamma voltage compensation circuit is configured to connect the gamma chip and the display panel.

The gamma voltage compensation circuit, the compensation method and the display device disclosed in the present application have the following beneficial effects:

In the present application, the rectifier is connected to the frame start signal line for converting a frame start signal into a reference voltage. The reference voltage is positively related with the refresh rate. The compensator is connected to the rectifier for generating a gamma compensation voltage based on the reference voltage. The input sub-circuit is connected to the gamma chip for inputting a base gamma voltage. The output sub-circuit is connected to the input sub-circuit, the compensator and the display panel for superimposing the base gamma voltage and the gamma compensation voltage to generate the target gamma voltage and output the target gamma voltage to the data driver chip of the display panel, and the voltage difference between the target gamma voltage and the common voltage is negatively related with the reference voltage. When the refresh rate is high, the gamma voltage compensation circuit pulls down the voltage difference between the target gamma voltage and the common voltage, so that the brightness of the display screen is reduced, and when the refresh rate is low, the gamma voltage compensation circuit pulls up the voltage difference between the target gamma voltage and the common voltage, so that the brightness of the display screen is increased, and the flicker of the display screen can be reduced or eliminated.

Other features and advantages of the present application will become apparent by the following detailed description, or will be acquired in part by practice of the present application.

It should be understood that the above general description and the detailed description that follows are exemplary and explanatory only and do not limit the present disclosure.

### BRIEF DESCRIPTION OF THE DRAWINGS

The accompanying drawings herein are incorporated into and form a part of the specification, illustrate embodiments in accordance with the present application, and are used in conjunction with the specification to explain the principles of the present application. It will be apparent that the accompanying drawings in the following description are only some of the embodiments of the present application, and that for those skilled in the art, other accompanying drawings may be obtained from these drawings without any creative labour.

FIG. 1 is a block diagram of a gamma voltage compensation circuit in a first embodiment of the present application.

FIG. 2 is a schematic view of frame start signals of different frequencies in the first embodiment of the present application.

FIG. 3 is a schematic view of a gamma voltage compensation circuit in the first embodiment of the present application.

FIG. 4 is a flowchart of a gamma voltage compensation method in a second embodiment of the present application.

FIG. 5 is a block diagram of a display device in the second embodiment of the present application.

### DETAILED DESCRIPTION OF THE EMBODIMENTS

Embodiments will now be described more fully with reference to the accompanying drawings. However, the embodiments can be implemented in a variety of forms and should not be construed as limitation to the examples set forth herein; rather, the provision of these embodiments allows the present application to be more comprehensive and complete and conveys the idea of the embodiments in a comprehensive manner to those skilled in the art.

In addition, the described features, structures, or characteristics may be combined in one or more embodiments in any suitable manner. In the following description, many specific details are provided thereby giving a full understanding of the embodiments of the present application. However, those skilled in the art will realize that it is possible to practice the technical embodiments of the present application without one or more of the specific details, or that other methods, components, devices, steps, etc. may be employed. In other cases, the well-known methods, devices, implementations, or operations are not shown or described in detail to avoid blurring aspects of the present application.

The present application is described in further detail below in connection with the accompanying drawings and specific embodiments. It should be noted herein that the technical features involved in the various embodiments of the present application described below may be combined with each other, as long as they do not constitute a conflict with each other. The embodiments described below by reference to the accompanying drawings are exemplary and are intended to be used for explaining the present application and are not to be construed as a limitation to the present application.

### First Embodiment

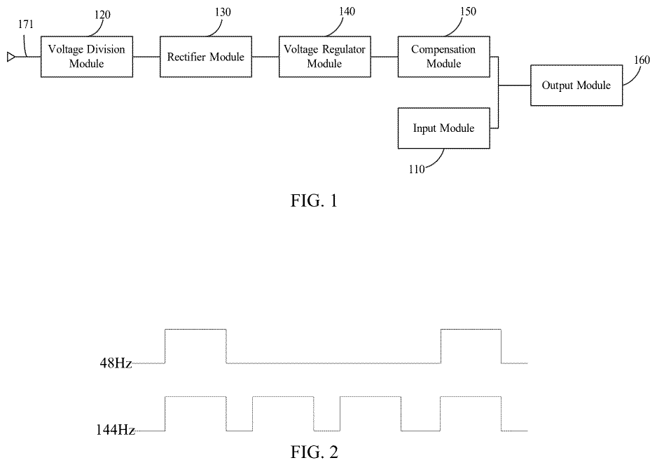

Referring to FIG. 1, the gamma voltage compensation circuit in this embodiment includes an input sub-circuit 110, a rectifier 130, a compensator 150, and an output sub-circuit 160.

A duty cycle of the frame start signal STV is different at different refresh rates, the higher the refresh rate, the larger the duty cycle of the frame start signal STV, and the lower the refresh rate, the smaller the duty cycle of the frame start signal STV. For example, as shown in FIG. 2, when the refresh rate is 48 Hz, the duty cycle of the frame start signal STV is smaller; and when the refresh rate is 144 Hz, the duty cycle of the frame start signal STV is larger. The rectifier 130 is connected to the frame start signal line 171, the frame start signal line 171 outputs the frame start signal STV. The rectifier 130 is configured to convert the frame start signal STV into a reference voltage Vref. The higher the refresh rate, the higher the reference voltage Vref converted by the rectifier 130, and the lower the refresh rate, the lower the reference voltage Vref converted by the rectifier 130.

The compensator 150 is connected to the rectifier 130 for generating a gamma compensation voltage based on the reference voltage Vref. The input sub-circuit 110 is connected to the gamma chip for inputting a base gamma voltage. The output sub-circuit 160 is connected to the input sub-circuit 110, the compensator 150 and the display panel 200 for superimposing the base gamma voltage and the gamma compensation voltage to generate a target gamma voltage and outputting the target gamma voltage to a data driver chip (Source Driver) of the display panel 200.

A voltage difference between the target gamma voltage and the common voltage Vcom is negatively related with the reference voltage Vref. That is, the higher the reference voltage Vref, the lower the voltage difference between the target gamma voltage and the common voltage Vcom. The lower the reference voltage Vref, the higher the voltage difference between the gamma compensation voltage and the common voltage Vcom. The voltage difference between the target gamma voltage and the common voltage Vcom affects the brightness of the display panel 200, the higher the voltage difference between the target gamma voltage and the common voltage Vcom, the higher the brightness of the display panel. The lower the voltage difference between the target gamma voltage and the common voltage Vcom, the lower the brightness of the display panel.

In summary, the higher the refresh rate, the higher the reference voltage Vref converted by the rectifier 130, the lower the voltage difference between the target gamma voltage and the common voltage Vcom, the lower the brightness of the display panel. The lower the refresh rate, the lower the reference voltage Vref converted by the rectifier 130, the higher the voltage difference between the target gamma voltage and the common voltage Vcom, the higher the brightness of the display panel.

The variable refresh rate mode allows the display panel 200 to achieve a refresh display from 48 Hz to 144 Hz, the higher the refresh rate, the less the current leakage of the transistor, the higher the brightness of the display screen. The lower the refresh rate, the more the current leakage of the transistor, the lower the brightness of the display screen, i.e., the switching of the refresh rate of the display panel 200 results in visible flicker on the display screen.

In the present application, the rectifier 130 is connected to the frame start signal line 171 for converting the frame start signal STV into the reference voltage Vref. The reference voltage Vref is positively related with the refresh rate. The compensator 150 is connected to the rectifier 130 for generating the gamma compensation voltage based on the reference voltage Vref. The input sub-circuit 110 is connected to the gamma chip for inputting a base gamma voltage. The output sub-circuit 160 is connected to the input sub-circuit 110,, the compensator 150 and the display panel 200 for superimposing the base gamma voltage and the gamma compensation voltage to generate the target gamma voltage, and outputting the target gamma voltage to the data driver chip of the display panel 200. The voltage difference between the target gamma voltage and the common voltage Vcom is negatively related with the reference voltage Vref. When the refresh rate is high, the gamma voltage compensation circuit pulls down the voltage difference between the target gamma voltage and the common voltage Vcom, so that the brightness of the display screen is reduced, and when the refresh rate is low, the gamma voltage compensation circuit pulls up the voltage difference between the target gamma voltage and the common voltage Vcom, so that the brightness of the display screen is increased, and the flicker of the display screen can be reduced or eliminated.

Referring to FIGS. 1 to 3, the input sub-circuit 110 includes a first input line 111 and a second input line 112. The compensator 150 includes a first compensator 151 and a second compensator 152. The output sub-circuit 160 includes a first output sub-circuit 161 and a second output sub-circuit 162. The first compensator 151 is configured to connect the first input line 111 and the first output sub-circuit 161, and the second compensator 152 is configured to connect the second input line 112 and the second output sub-circuit 162.

The base gamma voltage includes a positive polarity base gamma voltage UH1 and a negative polarity base gamma voltage LL1. When the gamma voltage is higher than the common voltage Vcom, the gamma voltage is the positive polarity base gamma voltage UH1. When the gamma voltage is lower than the common voltage Vcom, the gamma voltage is the negative polarity base gamma voltage LL1.

The first input line 111 is used to input the positive polarity base gamma voltage UH1 to the first output sub-circuit 161, and the second input line 112 is used to input the negative polarity base gamma voltage LL1 to the second output sub-circuit 162.

When the refresh rate is high, the rectifier 130 outputs a higher reference voltage Vref, the first compensator 151 outputs a lower positive polarity compensation voltage UH2 based on the reference voltage Vref, and the second compensator 152 outputs a higher negative polarity compensation voltage LL2 based on the reference voltage Vref. The positive polarity base gamma voltage UH1 and the positive polarity compensation voltage UH2 are superimposed to generate a positive polarity target gamma voltage UH0, and the negative polarity base gamma voltage LL1 and the negative polarity compensation voltage LL2 are superimposed to generate a negative polarity target gamma voltage LL0. Regardless of whether the target gamma voltage is the positive polarity target gamma voltage UH0 or the negative polarity target gamma voltage LL0, the voltage difference between the target gamma voltage and the common voltage Vcom is pulled down, so that the brightness of the display screen is reduced.

Accordingly, when the refresh rate is low, the reference voltage Vref output by the rectifier 130 is low, the first compensator 151 outputs a higher positive polarity compensation voltage UH2 based on the reference voltage Vref, and the second compensator 152 outputs a lower negative polarity compensation voltage LL2 based on the reference voltage Vref. Regardless of whether the target gamma voltage is the positive polarity target gamma voltage UH0 or the negative polarity target gamma voltage LL0, the voltage difference between the target gamma voltage and the common voltage Vcom is pulled up, so that the brightness of the display screen is increased.

When the refresh rate is high, the gamma voltage compensation circuit pulls down the voltage difference between the target gamma voltage and the common voltage Vcom, to reduce the brightness of the display screen that has been increased due to the less current leakage of the transistor. When the refresh rate is low, the gamma voltage compensation circuit pulls up the voltage difference between the target gamma voltage and the common voltage Vcom, to increase the brightness of the display screen that has been lowered due to the more current leakage of the transistor, which can reduce or eliminate the flicker of the display screen.

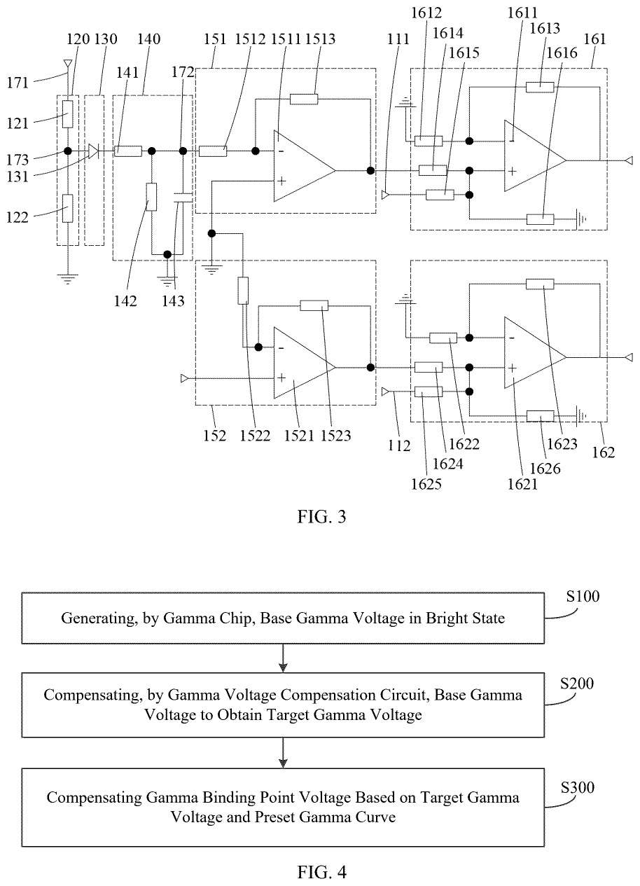

Exemplarily, referring to FIG. 3, the first compensator 151 includes a first operational amplifier 1511, a first resistor 1512, and a second resistor 1513. The first operational amplifier 1511 has an in-phase input, an inverted-phase input, and an output. The inverted-phase input of the first operational amplifier 1511 is connected to the rectifier 130 through the first resistor 1512, and the inverted-phase input and the output of the first operational amplifier 1511 are connected through the second resistor 1513. The in-phase input of the first operational amplifier 1511 is grounded.

When the refresh rate is high, the reference voltage Vref output by the rectifier 130 is high, and the first operational amplifier 1511 outputs a lower positive polarity compensation voltage UH2 based on the reference voltage Vref, to reduce the brightness of the display screen that has been increased due to the less current leakage of the transistor. When the refresh rate is low, the reference voltage Vref output by the rectifier 130 is low, and the first operational amplifier 1511 outputs a higher positive polarity compensation voltage UH2 based on the reference voltage Vref, to increase the brightness of the display screen that has been lowered due to the more current leakage of the transistor.

Exemplary, referring to FIG. 3, the second compensator 152 includes a second operational amplifier 1521, a third resistor 1522, and a fourth resistor 1523. The second operational amplifier 1521 has an in-phase input, an inverted-phase input, and an output. The inverted-phase input of the second operational amplifier 1521 is grounded through the third resistor 1522. The inverted-phase input and the output of the second operational amplifier 1521 are connected through the fourth resistor 1523, and the in-phase input of the second operational amplifier 1521 is connected to the rectifier 130.

When the refresh rate is high, the reference voltage Vref output by the rectifier 130 is high, and the second operational amplifier 1521 outputs a higher negative polarity compensation voltage LL2 based on the reference voltage Vref, to reduce the higher brightness of the display screen caused by the less current leakage of the transistor. When the refresh rate is low, the reference voltage Vref output by the rectifier 130 is low, and the second operational amplifier 1521 outputs a lower negative polarity compensation voltage LL2 based on the reference voltage Vref, to reduce the lower brightness of the display screen caused by the more current leakage of the transistor.

Referring to FIG. 3, the first output sub-circuit 161 includes a third operational amplifier 1611, a fifth resistor 1612, a sixth resistor 1613, a seventh resistor 1614, an eighth resistor 1615, and a ninth resistor 1616. The third operational amplifier 1611 has an in-phase input, an inverted-phase input, and an output. The inverted-phase input of the third operational amplifier 1611 is grounded through the fifth resistor 1612. The inverted-phase input and the output of the third operational amplifier 1611 are connected through the sixth resistor 1613. The in-phase input of the third operational amplifier 1611 is connected to the first compensator 151 through the seventh resistor 1614, specifically connected to the output of the first operational amplifier 1511. The in-phase input of the third operational amplifier 1611 is connected to the first input line 111 through the eighth resistor 1615. The in-phase input of the third operational amplifier 1611 is grounded through the ninth resistor 1616.

That is, the positive polarity base gamma voltage UH1 output from the first input line 111 and the positive polarity compensation voltage UH2 output from the first operational amplifier 1511 are superimposed to generate the positive polarity target gamma voltage UH0.

When the refresh rate is high, the first operational amplifier 1511 outputs a lower positive polarity compensation voltage UH2, and the lower positive polarity compensation voltage UH2 and the positive polarity base gamma voltage UH1 are superimposed to generate the lower positive polarity target gamma voltage UH0, to reduce the higher brightness of the display screen caused by the less current leakage of the transistor. When the refresh rate is low, the first operational amplifier 1511 outputs the higher positive polarity compensation voltage UH2, and the higher positive polarity compensation voltage UH2 and the positive polarity base gamma voltage UH1 are superimposed to generate a higher positive polarity target gamma voltage UH0, to increase the lower brightness of the display screen caused by the more current leakage of the transistor.

Referring to FIG. 3, the second output sub-circuit 162 includes a fourth operational amplifier 1621, a tenth resistor 1622, an eleventh resistor 1623, a twelfth resistor 1624, a thirteenth resistor 1625, and a fourteenth resistor 1626. The fourth operational amplifier 1621 has an in-phase input, an inverted-phase input, and an output. The inverted-phase input of the fourth operational amplifier 1621 is grounded through the tenth resistor 1622. The inverted-phase input and the output of the fourth operational amplifier 1621 are connected through the eleventh resistor 1623. The in-phase input of the fourth operational amplifier 1621 is connected to the second compensator 152 through the twelfth resistor 1624, specifically to the output of the second operational amplifier 1521. The in-phase input of the fourth operational amplifier 1621 is connected to the second input line 112 through the thirteenth resistor 1625, and the in-phase input of the fourth operational amplifier 1621 is grounded through the fourteenth resistor 1626.

That is, the negative polarity base gamma voltage LL1 output from the second input line 112 and the negative polarity compensation voltage LL2 output from the second operational amplifier 1521 are superimposed to generate the negative polarity target gamma voltage LL0.

When the refresh rate is high, the second operational amplifier 1521 outputs a higher negative polarity compensation voltage LL2, and the higher negative polarity compensation voltage LL2 and the negative base gamma voltage LL1 are superimposed to generate a higher negative target gamma voltage LL0, to reduce the brightness of the display screen caused by the low current leakage of the transistor. When the refresh rate is low, the second operational amplifier 1521 outputs a lower negative polarity compensation voltage LL2, and the lower negative polarity compensation voltage LL2 and the negative polarity base gamma voltage LL1 are superimposed to generate the lower negative polarity target gamma voltage LL0, to increase the lower brightness of the display screen caused by the more current leakage of the transistor.

Referring to FIG. 3, the rectifier 130 includes a diode 131. A positive pole of the diode 131 is connected to the frame start signal line 171, and a negative pole of the diode 131 is connected to the first compensator 151 and the second compensator 152. The first resistor 1512 of the first compensator 151 is connected to the negative pole of the diode 131, and the in-phase input of the second operational amplifier 1521 of the second compensator 152 is connected to the negative pole of the diode 131.

The frame start signal STV of the frame start signal line 171 is an alternative current (AC) signal, and the diode 131 may convert the AC signal into a direct current (DC) signal, and output the DC signal to the first compensator 151 and the second compensator 152.

It should be noted that the rectifier 130 may include the diode 131, but is not limited thereto, and the rectifier 130 may also include a bridge rectifier circuit, etc., which is specifically determined as actual.

Referring to FIG. 3, the gamma voltage compensation circuit further includes a voltage regulator 140. The voltage regulator 140 includes a fifteenth resistor 141, a sixteenth resistor 142, and a voltage regulator capacitor 143. The first compensator 151 and the second compensator 152 are connected through a first node 172, the fifteenth resistor 141 is configured to connect the first node 172 to the diode 131. The first node 172 is grounded through the sixteenth resistor 142. The first node 172 is also grounded through the voltage regulator capacitor 143.

The frame start signal STV of the frame start signal line 171 is an AC signal, and the diode 131 may convert the AC signal into a DC signal (i.e., a reference voltage Vref) and output the DC signal to the voltage regulator 140, which may reduce fluctuation of the reference voltage Vref and output the reference voltage Vref to the first compensator 151 and the second compensator 152.

Referring to FIG. 3, the gamma voltage compensation circuit further includes a voltage divider 120, and the voltage divider 120 includes a seventeenth resistor 121 and an eighteenth resistor 122. The seventeenth resistor 121 is configured to connect the frame start signal line 171 and the diode 131. The second node 173 between the seventeenth resistor 121 and the diode 131 is grounded through the eighteenth resistor 122.

The voltage divider 120 includes the seventeenth resistor 121 and the eighteenth resistor 122, and a voltage value of the reference voltage Vref can be adjusted by dividing the voltage through the seventeenth resistor 121 and the eighteenth resistor 122.

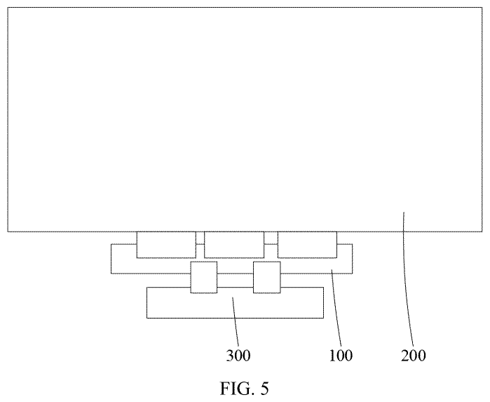

Second Embodiment Referring to FIG. 4, the gamma voltage compensation method in this embodiment includes:
S100: generating, by a gamma chip, a base gamma voltage in the bright state;
S200: compensating, by a gamma voltage compensation circuit, the base gamma voltage to obtain a target gamma voltage;
S300: compensating a gamma binding point voltage based on the target gamma voltage and a preset gamma curve.

The brightness of the display screen is indicated by the grayscale, taking the 256 grayscales of 8 bit display panel 200 as an example, the gamma chip provides the gamma binding point voltage (G7, G8) corresponding to 0 grayscales, the gamma binding point voltage (G6, G9) corresponding to 31 grayscales, the gamma binding point voltage (G5, G10) corresponding to 63 grayscales, the gamma binding point voltage (G4, G11) corresponding to 127 grayscales, the gamma binding point voltage (G3, G12) corresponding to 191 grayscales, the gamma binding point voltage (G2, G13) corresponding to 223 grayscales, the gamma binding point voltage (G1, G14) corresponding to 255 grayscales. The remaining 249 grayscales are generated internally by the data driver chip based on division of the above 7 sets of gamma binding point voltages.

The input sub-circuit 110 is connected to the gamma chip for inputting the base gamma voltage, which includes the base gamma voltage in the bright state, i.e., the gamma binding point voltage corresponding to the 255 grayscales (G1, G14). The compensator 150 generates a gamma compensation voltage based on the reference voltage Vref, the base gamma voltage and the gamma compensation voltage are superimposed to generate a target gamma voltage, and outputs the target gamma voltage to the data driver chip of the display panel 200. A preset gamma curve in the data driver chip meets curves of the gamma 2.2, and the compensated other gamma binding point voltages can be obtained based on the preset gamma curve.

It is to be noted that the base gamma voltage may include the base gamma voltage in the bright state, but is not limited thereto, and the base gamma voltage may also be other gamma binding point voltages, which are specifically determined as actual.

In this embodiment, the gamma chip generates the base gamma voltage in the bright state. The input sub-circuit 110 is connected to the gamma chip for inputting the base gamma voltage. The compensator 150 generates the gamma compensation voltage based on the reference voltage Vref. The base gamma voltage and the gamma compensation voltage are superimposed to generate the target gamma voltage, and the target gamma voltage is output to the data driver chip of the display panel 200. The voltage difference between the target gamma voltage and the common voltage Vcom is negatively related to the reference voltage Vref. When the refresh rate is high, the gamma voltage compensation circuit pulls down the voltage difference between the target gamma voltage and the common voltage Vcom, so that the brightness of the display screen is reduced. When the refresh rate is low, the gamma voltage compensation circuit pulls up the voltage difference between the target gamma voltage and the common voltage Vcom, so that the brightness of the display screen is increased, which can reduce or eliminate the flicker of the display screen.

### Third Embodiment

Referring to FIG. 5, the display device in this embodiment includes a voltage compensation circuit, a gamma chip, and a display panel 200. The gamma voltage compensation circuit is configured to connect the gamma chip and the display panel 200, and the gamma voltage compensation circuit includes the gamma voltage compensation circuit in the first embodiment.

In this embodiment, the display device includes the gamma voltage compensation circuit, and the rectifier 130 in the gamma voltage compensation circuit is connected to the frame start signal line 171 for converting the frame start signal STV into a reference voltage Vref. The reference voltage Vref is positively related with the refresh rate. The compensator 150 is connected to the rectifier 130 for generating a gamma compensation voltage based on the reference voltage Vref. The input sub-circuit 110 is connected to the gamma chip for inputting a base gamma voltage. The output sub-circuit 160 is connected to the input sub-circuit 110, the compensator 150, and the display panel 200 for superimposing the base gamma voltage and the gamma compensation voltage to generate a target gamma voltage and outputting the target gamma voltage to the data driver chip of the display panel 200. The voltage difference between the target gamma voltage and the common voltage Vcom is negatively relative with the reference voltage Vref. When the refresh rate is high, the gamma voltage compensation circuit pulls down the voltage difference between the target gamma voltage and the common voltage Vcom, so that the brightness of the display screen is reduced, and when the refresh rate is low, the gamma voltage compensation circuit pulls up the voltage difference between the target gamma voltage and the common voltage Vcom, so that the brightness of the display screen is increased, which can reduce or eliminate the flicker of the display screen.

Referring to FIG. 5, the display device further includes a main board 300, a horizontal direction circuit board 100, the horizontal direction circuit board 100 is configured to connect the display panel 200 and the main board 300, the gamma chip is provided on the main board 300, and the gamma voltage compensation circuit is provided on the horizontal direction circuit board 100.

The gamma voltage compensation circuit is provided on the horizontal direction circuit board 100. The base gamma voltage is compensated by a hardware circuit, which can reduce the amount of computation of the timing controller and improve the delay of the calling code of the timing controller, as compared with the scheme of compensating the base gamma voltage by software.

The terms “first”, “second”, etc. are used for descriptive purposes only, and are not to be understood as indicating or implying relative importance or implicitly specifying the number of technical features indicated. Thus, a feature defined with “first”, “second”, etc. may either explicitly or implicitly include one or more such features. In the description of the present application, “more than one” means two or more, unless otherwise expressly and specifically limited.

In the present application, unless otherwise expressly specified and limited, the terms “assembly”, “connection”, etc. are to be broadly construed, e.g., as a fixed connection, a detachable connection, or an integrated connection, a mechanical connection, or an electrical connection; or a direct connection or an indirect connection through an intermediate medium, a connection within two elements or an interaction between two elements. For those skilled in the art, the specific meanings of the above terms in the present application may be understood on a based on actual situation.

In the description of the present specification, the description with reference to the terms “some embodiments”, “exemplarily”, etc. means that specific features, structures, materials, or characteristics described in conjunction with the embodiments or examples are included in at least one embodiment or example of the present application. In this specification, schematic expressions of the above terms do not necessarily refer to the same embodiment or example. Moreover, the specific features, structures, materials, or characteristics described may be combined in a suitable manner in any one or more of the embodiments or examples. Furthermore, without contradicting each other, those skilled in the art may combine different embodiments or examples and features of different embodiments or examples described in this specification.

Although the embodiments of the present application have been shown and described above, it is understood that the above embodiments are exemplary and should not be construed as a limitation to the present application, and that those skilled in the art may make changes, modifications, replacement and variations to the above embodiments within the scope of the present application, and therefore any changes or modifications made in accordance with the claims and specification of the present application shall fall within the scope of the present application.

1. A gamma voltage compensation circuit, comprising:
an input sub-circuit, connected to a gamma chip for inputting a base gamma voltage;
a rectifier, connected to a frame start signal line for converting a frame start signal into a reference voltage;
a compensator, connected to the rectifier for generating a gamma compensation voltage based on the reference voltage; and
an output sub-circuit, connected to the input sub-circuit, the compensator and a display panel, for superimposing the base gamma voltage and the gamma compensation voltage to generate a target gamma voltage, and outputting the target gamma voltage to a data driver chip of the display panel;
wherein a voltage difference between the target gamma voltage and a common voltage is negatively related to the reference voltage.

2. The gamma voltage compensation circuit according to claim 1, wherein the input sub-circuit comprises a first input line and a second input line;
wherein the compensator comprises a first compensator and a second compensation compensator;
wherein the output sub-circuit comprises a first output sub-circuit and a second output sub-circuit;
wherein the first compensator is configured to connect the first input line to the first output sub-circuit, and the second compensator is configured to connect the second input line and the second output sub-circuit; and
wherein the base gamma voltage comprises a positive polarity base gamma voltage and a negative polarity base gamma voltage, and the first input line is configured for inputting the positive polarity base gamma voltage to the first output sub-circuit, and the second input line is configured for inputting the negative polarity base gamma voltage to the second output sub-circuit.

3. The gamma voltage compensation circuit according to claim 2, wherein the first compensator comprises a first operational amplifier, a first resistor and a second resistor;
wherein the first operational amplifier has an in-phase input, an inverted-phase input and an output;
wherein the inverted-phase input of the first operational amplifier is connected to the rectifier through the first resistor;
wherein the inverted-phase input and the output of the first operational amplifier are connected through the second resistor;
wherein the in-phase input of the first operational amplifier is grounded;
wherein the second compensator comprises a second operational amplifier, a third resistor and a fourth resistor;
wherein the second operational amplifier has an in-phase input, an inverted-phase input and an output;
wherein the inverted-phase input of the second operational amplifier is connected to grounded through the third resistor;
wherein the inverted-phase input and the output of the second operational amplifier are connected through the fourth resistor, and
wherein the in-phase input of the second operational amplifier is connected to the rectifier.

4. The gamma voltage compensation circuit according to claim 2, wherein the first output sub-circuit comprises a third operational amplifier, a fifth resistor, a sixth resistor, a seventh resistor, an eighth resistor and a ninth resistor;
wherein the third operational amplifier has an in-phase input, an inverted-phase input and an output;
wherein the inverted-phase input of the third operational amplifier is grounded through the fifth resistor;
wherein the inverted-phase input and the output of the third operational amplifier are connected through the sixth resistor;
wherein the in-phase input of the third operational amplifier is connected to the first compensator through the seventh resistor;
wherein the in-phase input of the third operational amplifier is connected to the first input line through the eighth resistor;
wherein the in-phase input of the third operational amplifier is grounded through the ninth resistor;
wherein the second output sub-circuit comprises a fourth operational amplifier, a tenth resistor, an eleventh resistor, a twelfth resistor, a thirteenth resistor and a fourteenth resistor;
wherein the fourth operational amplifier has an in-phase input, an inverted-phase input and an output;
wherein the inverted-phase input of the fourth operational amplifier is grounded through the tenth resistor;
wherein the inverted-phase input and the output of the fourth operational amplifier are connected through the eleventh resistor;
wherein the in-phase input of the fourth operational amplifier is connected to the second compensator through the twelfth resistor;
wherein the in-phase input of the fourth operational amplifier is connected to the second input line through the thirteenth resistor; and
wherein the in-phase input of the fourth operational amplifier is grounded through the fourteenth resistor.

5. The gamma voltage compensation circuit according to claim 2, wherein the rectifier comprises a diode, and a positive pole of the diode is connected to the frame start signal line, and a negative pole of the diode is connected to the first compensator and the second compensator.

6. The gamma voltage compensation circuit according to claim 5, wherein the gamma voltage compensation circuit further comprises a voltage regulator, and the voltage regulator comprises a fifteenth resistor, a sixteenth resistor, and a voltage regulator capacitor;
wherein the first compensator and the second compensator are connected through a first node;
wherein the fifteenth resistor is configured to connect the first node to the diode;
wherein the first node is grounded through the sixteenth resistor; and
wherein the first node is grounded through the voltage regulator capacitor.

7. The gamma voltage compensation circuit according to claim 6, wherein the gamma voltage compensation circuit further comprises a voltage divider, and the voltage divider comprises a seventeenth resistor and an eighteenth resistor;
wherein the seventeenth resistor is configured to connect the frame start signal line and the diode, and a second node between the seventeenth resistor and the diode is grounded through the eighteenth resistor.

8. The gamma voltage compensation circuit according to claim 1, wherein the frame start signal is an alternative current (AC) signal, and the reference voltage is a direct current (DC) signal.

9. A gamma voltage compensation method, comprising:
generating, by a gamma chip, a base gamma voltage in a bright state;
compensating, by a gamma voltage compensation circuit, the base gamma voltage to obtain a target gamma voltage; and
compensating a gamma binding point voltage based on the target gamma voltage and a preset gamma curve;
wherein the gamma voltage compensation circuit comprises:
an input sub-circuit, connected to the gamma chip for inputting the base gamma voltage;
a rectifier, connected to a frame start signal line for converting a frame start signal into a reference voltage;
a compensator, connected to the rectifier for generating a gamma compensation voltage based on the reference voltage; and
an output sub-circuit, connected to the input sub-circuit, the compensator and a display panel, for superimposing the base gamma voltage and the gamma compensation voltage to generate the target gamma voltage, and outputting the target gamma voltage to a data driver chip of the display panel;
wherein a voltage difference between the target gamma voltage and a common voltage is negatively related to the reference voltage.

10. The gamma voltage compensation method according to claim 9, wherein the input sub-circuit comprises a first input line and a second input line;
wherein the compensator comprises a first compensator and a second compensator;
wherein the output sub-circuit comprises a first output sub-circuit and a second output sub-circuit;
wherein the first compensator is configured to connect the first input line to the first output sub-circuit, and the second compensator is configured to connect the second input line and the second output output sub-circuit; and
wherein the base gamma voltage comprises a positive polarity base gamma voltage and a negative polarity base gamma voltage, and the first input line is configured for inputting the positive polarity base gamma voltage to the first output sub-circuit, and the second input line is configured for inputting the negative polarity base gamma voltage to the second output sub-circuit.

11. The gamma voltage compensation method according to claim 10, wherein the first compensator comprises a first operational amplifier, a first resistor and a second resistor;
wherein the first operational amplifier has an in-phase input, an inverted-phase input and an output;
wherein the inverted-phase input of the first operational amplifier is connected to the rectifier through the first resistor;
wherein the inverted-phase input and the output of the first operational amplifier are connected through the second resistor;
wherein the in-phase input of the first operational amplifier is grounded;
wherein the second compensator comprises a second operational amplifier, a third resistor and a fourth resistor;
wherein the second operational amplifier has an in-phase input, an inverted-phase input and an output;
wherein the inverted-phase input of the second operational amplifier is connected to grounded through the third resistor;
wherein the inverted-phase input and the output of the second operational amplifier are connected through the fourth resistor, and
wherein the in-phase input of the second operational amplifier is connected to the rectifier.

12. The gamma voltage compensation method according to claim 10, wherein the first output sub-circuit comprises a third operational amplifier, a fifth resistor, a sixth resistor, a seventh resistor, an eighth resistor and a ninth resistor;
wherein the third operational amplifier has an in-phase input, an inverted-phase input and an output;
wherein the inverted-phase input of the third operational amplifier is grounded through the fifth resistor;
wherein the inverted-phase input and the output of the third operational amplifier are connected through the sixth resistor;
wherein the in-phase input of the third operational amplifier is connected to the first compensator through the seventh resistor;
wherein the in-phase input of the third operational amplifier is connected to the first input line through the eighth resistor;
wherein the in-phase input of the third operational amplifier is grounded through the ninth resistor;
wherein the second output sub-circuit comprises a fourth operational amplifier, a tenth resistor, an eleventh resistor, a twelfth resistor, a thirteenth resistor and a fourteenth resistor;
wherein the fourth operational amplifier has an in-phase input, an inverted-phase input and an output;
wherein the inverted-phase input of the fourth operational amplifier is grounded through the tenth resistor;
wherein the inverted-phase input and the output of the fourth operational amplifier are connected through the eleventh resistor;
wherein the in-phase input of the fourth operational amplifier is connected to the second compensator through the twelfth resistor;
wherein the in-phase input of the fourth operational amplifier is connected to the second input line through the thirteenth resistor; and
wherein the in-phase input of the fourth operational amplifier is grounded through the fourteenth resistor.

13. The gamma voltage compensation method according to claim 10, wherein the rectifier comprises a diode, and a positive pole of the diode is connected to the frame start signal line, and a negative pole of the diode is connected to the first compensator and the second compensator.

14. The gamma voltage compensation method according to claim 13, wherein the gamma voltage compensation circuit further comprises a voltage regulator, and the voltage regulator comprises a fifteenth resistor, a sixteenth resistor, and a voltage regulator capacitor;
wherein the first compensator and the second compensator are connected through a first node;
wherein the fifteenth resistor is configured to connect the first node to the diode;
wherein the first node is grounded through the sixteenth resistor; and
wherein the first node is grounded through the voltage regulator capacitor.

15. The gamma voltage compensation method according to claim 14, wherein the gamma voltage compensation circuit further comprises a voltage divider, and the voltage divider comprises a seventeenth resistor and an eighteenth resistor;
wherein the seventeenth resistor is configured to connect the frame start signal line and the diode, and a second node between the seventeenth resistor and the diode is grounded through the eighteenth resistor.

16. The gamma voltage compensation method according to claim 9, wherein the frame start signal is an alternative current (AC) signal, and the reference voltage is a direct current (DC) signal.

17. A display device, comprising a gamma voltage compensation circuit, a gamma chip and a display panel, wherein the gamma voltage compensation circuit is configured to connect the gamma chip and the display panel;
wherein the gamma voltage compensation circuit comprises:
an input sub-circuit, connected to the gamma chip for inputting a base gamma voltage;
a rectifier, connected to a frame start signal line for converting a frame start signal into a reference voltage;
a compensator, connected to the rectifier for generating a gamma compensation voltage based on the reference voltage; and
an output sub-circuit, connected to the input sub-circuit, the compensator and the display panel, for superimposing the base gamma voltage and the gamma compensation voltage to generate a target gamma voltage, and outputting the target gamma voltage to a data driver chip of the display panel;
wherein a voltage difference between the target gamma voltage and a common voltage is negatively related to the reference voltage.

18. The display device according to claim 17, further comprising a main board, and a horizontal direction circuit board, wherein the horizontal direction circuit board is configured to connect the display panel and the main board, and the gamma chip is provided on the main board, and the gamma voltage compensation circuit is provided on the horizontal direction circuit board.

19. The display device according to claim 17, wherein the input sub-circuit comprises a first input line and a second input line;
wherein the compensator comprises a first compensator and a second compensator;
wherein the output sub-circuit comprises a first output sub-circuit and a second output sub-circuit;
wherein the first compensator is configured to connect the first input line to the first output sub-circuit, and the second compensator is configured to connect the second input line and the second output sub-circuit; and
wherein the base gamma voltage comprises a positive polarity base gamma voltage and a negative polarity base gamma voltage, and the first input line is configured for inputting the positive polarity base gamma voltage to the first output sub-circuit, and the second input line is configured for inputting the negative polarity base gamma voltage to the second output sub-circuit.

20. The display device according to claim 19, wherein the first compensator comprises a first operational amplifier, a first resistor and a second resistor;
wherein the first operational amplifier has an in-phase input, an inverted-phase input and an output;
wherein the inverted-phase input of the first operational amplifier is connected to the rectifier through the first resistor;
wherein the inverted-phase input and the output of the first operational amplifier are connected through the second resistor;
wherein the in-phase input of the first operational amplifier is grounded;
wherein the second compensator comprises a second operational amplifier, a third resistor and a fourth resistor;
wherein the second operational amplifier has an in-phase input, an inverted-phase input and an output;
wherein the inverted-phase input of the second operational amplifier is connected to grounded through the third resistor;
wherein the inverted-phase input and the output of the second operational amplifier are connected through the fourth resistor, and
wherein the in-phase input of the second operational amplifier is connected to the rectifier.

21-25. (canceled)
